(19) United States
(12) Patent Application Publication
(10) Pub. No.: US 2008/0172883 A1
(43) Pub. Date: Jul. 24, 2008

(54) Measuring, scoring and cutting tool

(75) Inventors: Anthony F. Whitemiller, Naperville, IL (US); Brent W. Murray, Longmont, CO (US); Ronald A. Angstead, Longmont, CO (US); Clinton L. Percy, Erie, CO (US)

Correspondence Address: THE LAW FIRM OF HARRIS & BURDICK;HAROLD BURDICK AND ROBERT HARRIS, 6676 GUNPARK DRIVE, SUITE E, BOULDER, CO, 80301, US

(73) Assignee: Accurate Concepts, Inc.

(21) Appl. No.: 11/656,544

(22) Filed: Jan. 23, 2007

(51) Int. Cl. B26B 11/00

(52) U.S. Cl. 30/123

(57) ABSTRACT

A hand tool for measuring, scoring and cutting construction materials is disclosed. The tool includes a housing having first and second opposed walls, with a cutting blade opening and a catch at one end thereof. A pivot is located at an opposite end of the housing. A securement having a nose and a tail is pivotably held at the housing between the walls and is deployable therefrom, the tail connected at the pivot. The nose of the securement includes a cutting blade positioning portion, a tape measure blade receiving slot and a latching structure that is releasably engageable with the catch of the housing when the securement is pivoted to an operative position. Structure defining the tape measure blade receiving slot preferably includes a lip releasably engagable at the anchoring gap feature found in the blades of most typical tape measures.

### FIELD OF THE INVENTION

This invention relates to utility-type knives and, more particularly, relates to tools for measuring, scoring and cutting construction materials such as drywall or the like.

### BACKGROUND OF THE INVENTION

Various hand tools utilized for cutting construction materials such as drywall or the like have been widely utilized and include such standard single use tools as keyhole saws and utility knives. Moreover, hand tools that combine measuring and cutting utility in a single tool (among other utilities) are also known and utilized (see U.S. Patent Publication No. US-2005-0022390-A1, and U.S. Pat. Nos. 6,367,154, 5,289,637, 4,993,093 and 4,255,856). Such heretofore known combined utility tools have not always proven convenient to use in all circumstances, however, some tools being considered too large for all applications. Such failure has typically led users back to the well known single use tools, even though inconvenient. Further improvements in such multiple use combined tools could, therefore, still be utilized.

In addition, various heretofore known cutting tools such as utility knives have included releasable structures incorporating center blade positioning and/or storage (see U.S. Pat. Nos. 6,718,637, 5,426,855 and 5,386,632, for example). Such tools, while allowing for easy access to cutting blades, have often proven unwieldy or unduly complex to operate, some risking loss of parts during use, and have typically been expensive to manufacture (incorporating a high number of parts). Moreover, such heretofore known tools have not always been completely safe to use, and often lack the durability necessary for repeated and rugged use in the field. Improvements in such features of these tools could also, therefore, be utilized.

### SUMMARY OF THE INVENTION

This invention provides an improved tool for measuring, scoring and cutting construction materials such as drywall and the like. The improved hand tool of this invention combines measuring and cutting utilities, and includes a releasable central blade securement structure allowing ready cutting blade repositioning and access to blade storage (especially convenient in a fixed blade position tool of this type). Cutting (and scoring) blade access and repositioning operations are accomplished with a minimum of complexity and risk of lost parts. The tool is compact, is convenient to use and store, is safe and durable, and is relatively inexpensive to manufacture.

The tool is particularly suitable for measuring, scoring and cutting construction materials such as drywall and the like, and is configured for use with a tape measure having a tape measure blade at one end. Typically, such tape measures also include a blade anchoring gap through the blade. The measuring and cutting tool of this invention (a hand tool) includes a housing having first and second opposed walls and a cutting blade opening, the cutting blade opening preferably being defined between the opposed walls. A securement is held at the housing between the first and second opposed walls and is deployable therefrom. A cutting blade positioning portion is located at one end of the securement, and a tape measure blade receiving slot is defined in the securement adjacent to the cutting blade positioning portion.

The housing has a catch located at the one end and a pivot located at one of the walls adjacent to a second end of the housing opposite the one end. The securement has a nose and a tail, the tail connected at the pivot of the housing for pivotable deployment of the securement from the housing. The nose of includes the cutting blade positioning portion and the tape measure blade receiving slot, and further includes a latching structure that is releasably engageable with the catch of the housing when the securement is pivoted to an operative position.

While preferably located at the securement, the tape measure blade receiving slot structure of the tool this invention may be defined by either or both the housing and/or the securement. The slot structure preferably includes an engagement releasably engagable at the blade anchoring gap of the tape measure blade when the tape measure blade is inserted into the receiving slot structure.

It is therefore an object of this invention to provide an improved tool for measuring, scoring and cutting.

It is another object of this invention to provide an improved hand tool combining measuring and cutting utilities.

It is still another object of this invention to provide and improved measuring and cutting tool that includes a releasable central blade securement structure (for both cutting and tape measure blades) that accommodates ease of cutting blade repositioning and of access to blade storage.

It is yet another object of this invention to provide a tool for measuring, scoring and cutting that is simple, safe and convenient to use and that is compact and durable.

It is another object of this invention to provide a tool for measuring and cutting that has a minimum of parts and is thus inexpensive to manufacture.

It is still another object of this invention to provide a measuring and cutting tool having a housing including first and second opposed walls and a cutting blade opening, and a securement held at the housing between the first and second opposed walls and deployable therefrom, the securement including a cutting blade positioning portion at one end thereof and a tape measure blade receiving slot at the one end adjacent to the cutting blade positioning portion.

It is still another object of this invention to provide a hand tool for measuring and cutting that has a housing including first and second opposed walls and a cutting blade opening at one end of the housing and defined between the opposed walls, the housing having a catch located at the one end and a pivot located at the first opposed wall adjacent to a second end of the housing opposite the one end, and a securement having a nose and a tail, the tail connected at the pivot of the housing for pivotable deployment of the securement from the housing, the nose of the securement including a cutting blade positioning portion, a tape measure blade receiving slot and a latching structure, the latching structure releasably engageable with the catch of the housing when the securement is pivoted to an operative position.

It is yet another object of this invention to provide a tool for measuring, scoring and cutting and configured for use with a tape measure having a tape measure blade at one end, the tape measure blade having a blade anchoring gap therethrough, the tool including a housing having a cutting blade opening at one end, a releasable securement locatable in the housing for positioning a cutting blade in the housing, and a tape measure blade receiving slot structure defined at least at one of the housing and the securement, the slot structure including an engagement releasably engagable at the blade anchoring gap of the tape measure blade when the tape measure blade is inserted into the receiving slot structure.

With these and other objects in view, which will become apparent to one skilled in the art as the description proceeds, this invention resides in the novel construction, combination, and arrangement of parts substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view of the tool of this invention;

FIG. 2 is a second perspective view of the tool shown in FIG. 1;

FIG. 3 is a perspective view of the tool shown in FIG. 1 with the pivotable securement for blades (both knife and tape measure blades) opened;

FIG. 4 is an exploded view of the tool shown in FIG. 1;

FIG. 5 is second exploded view of the tool shown in FIG. 1;

FIG. 6 is first sectional view of the tool shown in FIG. 1 illustrating capture of the cutting, stored and tape measure blades;

FIG. 7 is reverse sectional view of the tool taken opposite the pivotable blade securement relative to FIG. 6;

FIG. 8 is a partial plan view of an end portion of pivotable securement for blades; and

FIG. 9 a reverse partial plan view of the end portion of the pivotable securement as shown in FIG. 8.

### DESCRIPTION OF THE INVENTION

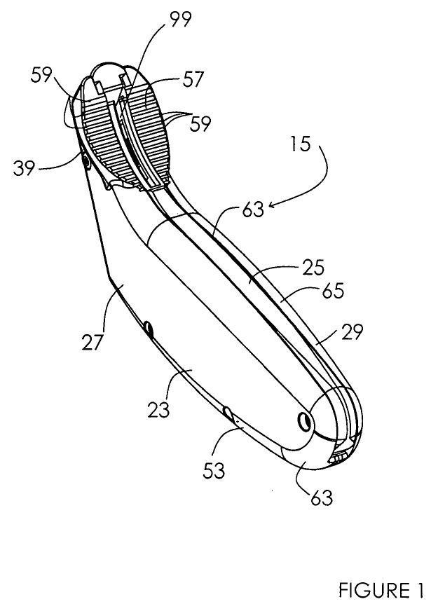

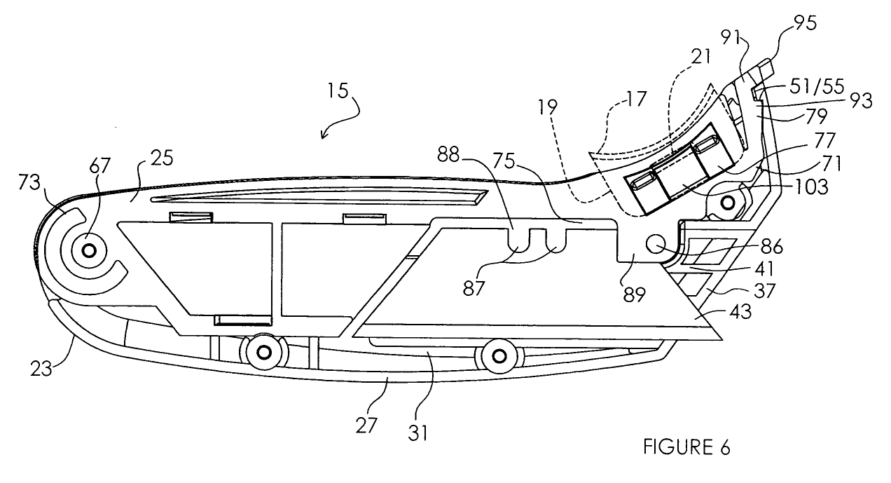

Measuring and cutting tool 15 of this invention is shown in FIGS. 1 through 7. This hand tool is primarily designed to accommodate measuring, scoring and cutting of construction materials such as drywall or the like, and is particularly configured for use with a standard tape measure 17 having a tape measure blade 19 at one end, such tape measure blades typically having a blade anchoring gap 21 therethrough (see FIG. 6).

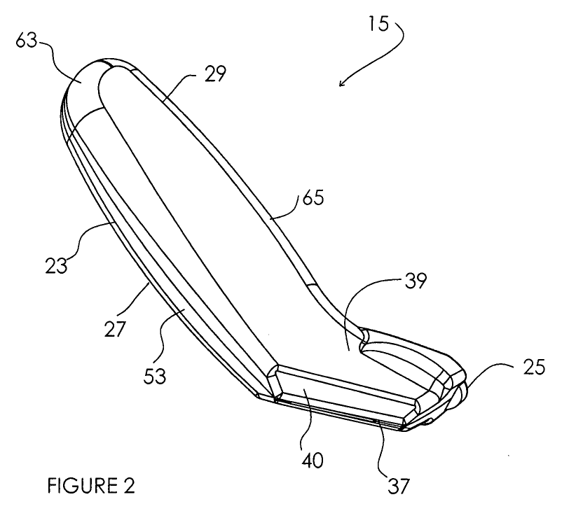

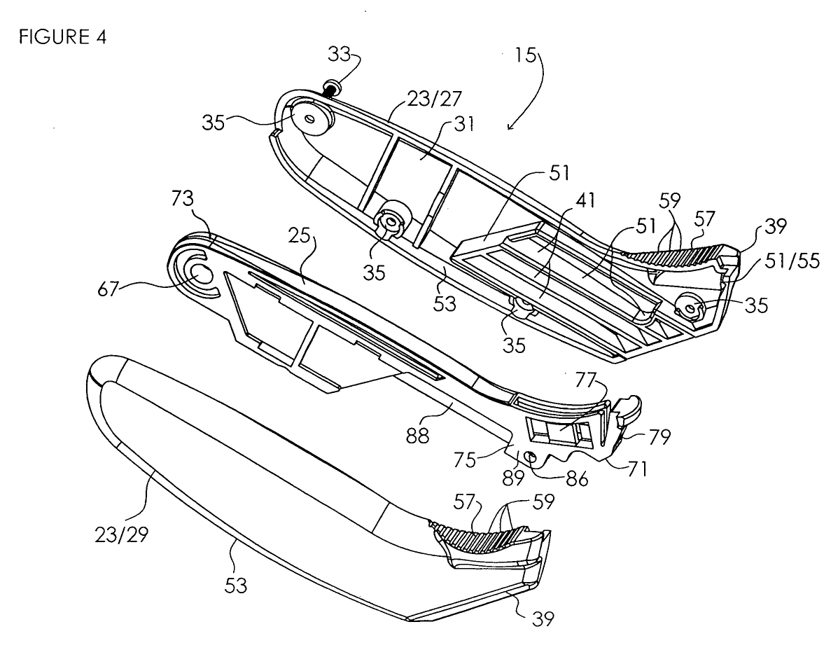

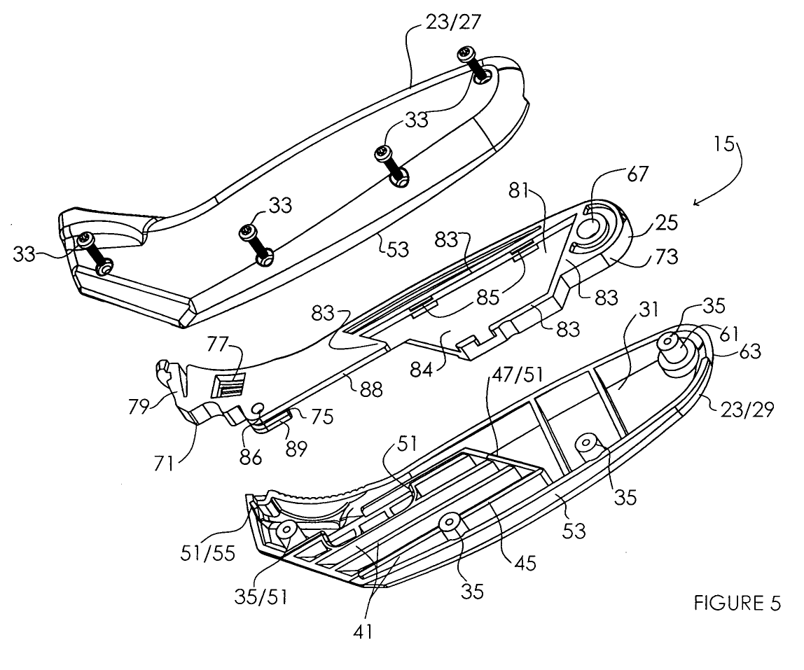

Tool 15 includes housing 23 and releasable securement 25. Housing 23 is defined by first and second housing portions 27 and 29, respectively, each having an inner opposed wall 31. Housing portion 27 and 29 are secured by screws or rivets 33 (or any other means) utilizing known structures (for example, mounting posts 35—see FIGS. 4 and 5). Cutting blade opening 37 is located through housing 23 at housing end 39 (see FIG. 2), and is defined between opposed walls 31 of each housing portion 27 and 29. The housing portions may be contoured as desired, though the beveled (narrowed) walls 40 adjacent to end 39 are desirable to allow easy access by the cutting blade in corners.

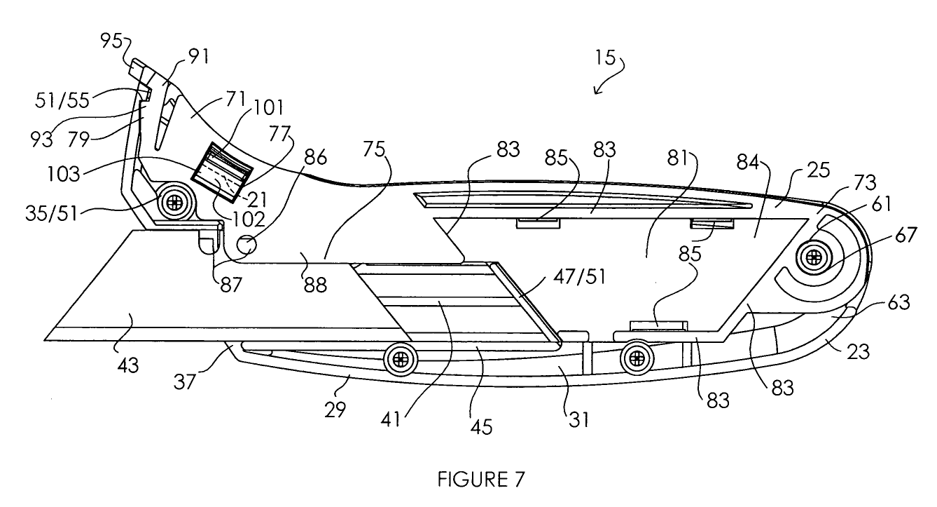

Blade positioning structural features 41 (shown in FIGS. 4 through 7) at inner opposed walls 31 of each housing portion 27 and 29 together define a receiving and securing path for cutting blade 43. Structural features 41 at inner wall 31 of housing portion 29 include bottom and side raised fins 45 and 47, respectively (see FIGS. 5 and 7), providing movement limiting guides for cutting blade 43 housed thereat (these fins are raised relative to adjacent fins of the related structural features 41 at housing portion 29).

As shown in FIGS. 4 and 5, at least one, and preferably both, of the opposed walls 31 at housing portions 27 and 29 have various securement 25 locating structures 51 defined thereat (side fin 47 as well as parts of features 41 and one of the posts 35 serving this function as well). These structures locate and limit pivoting movement of securement 25 in one direction (toward bottom 53 of housing 23), reduce general movement (rattle, for example) of the securement in the housing when held therein, and, at catch 55, aid in the releasably retention of securement 25 in housing 23. Housing portions 27 and 29 of housing 23 are configured at end 39 with a widened, elevated and arcuate surface 57 opposite cutting blade opening 37 (see FIGS. 1, 3 and 4). Gripping striations 59 are formed thereat to improve thumb grip to reduce slipping during cutting operations.

Pivot 61 is located at end 63 of housing 23 at portion 29 (FIGS. 5 and 7). Housing portions 27 and 29 are configured so that housing 23 is fully closed along bottom 53 but has a securement receiving slot 63 defined along top 65 of the housing allowing pivoting movement of securement 25 into and out of housing 23 (see FIGS. 1 through 3). Releasable securement 25 includes mount 67 (an opening) pivotably receivable at pivot 61. Securement 25 is thus deployable from housing 23 through slot 63 (it being correctly located while in housing 23 by structures 51) for positioning or repositioning cutting blades 43 (including stored blades) in housing 23.

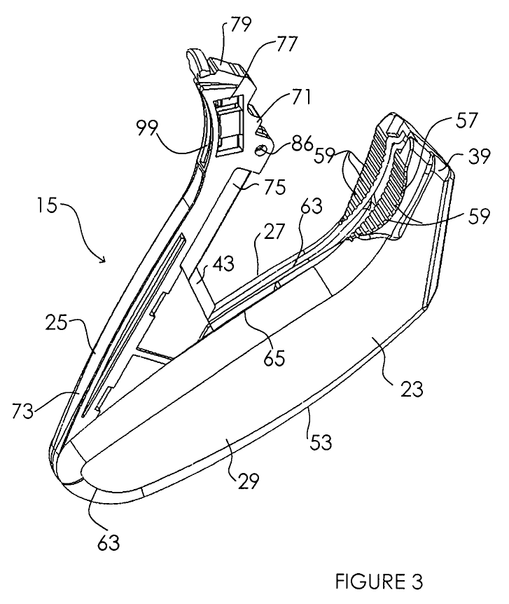

Turning to FIGS. 3 through 7, securement 25 includes nose portion 71 at one end and tail portion 73 spaced therefrom at the opposite end, tail portion 73 having mount 67 thereat. Nose portion 71 of securement 25 includes cutting blade positioning portion 75, tape measure blade receiving slot structure 77 and latching structure 79 thereat. A spare blade retainer structure 81 is located between cutting blade positioning portion 75 and mount 67, and is defined by raised retaining walls 83 surrounding bed 84 (see FIGS. 5 and 7). Blade retention ribs 85 secure spare blades at bed 84 (beneath the ribs) and prevent spare blade rattle.

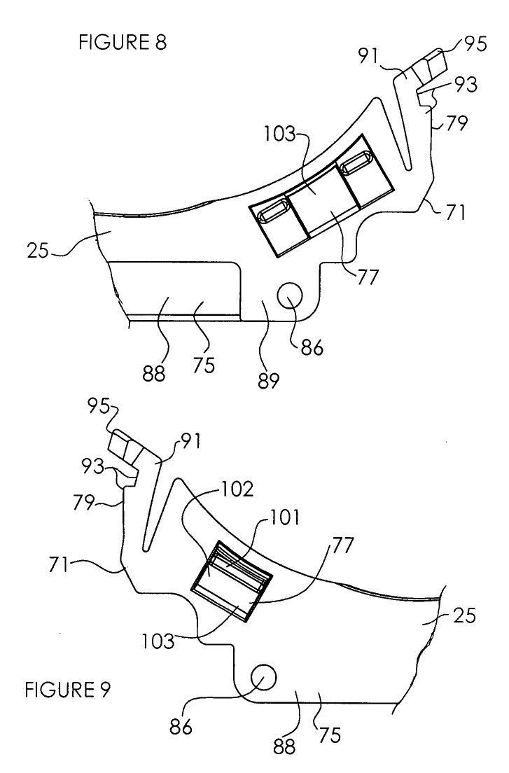

Cutting blade positioning portion 75 of nose portion 71 of securement 25 includes at least one cutting blade locating node 86 extending therethrough (a pin, for example) to either abut blade 43 at one end of the blade (FIG. 6) or engage a positioning notch 87 of blade 43 (FIG. 7) for user selection of different available blade installation positions/locations relative to cutting blade opening 37 from housing 23. Such fixed blade positions are selected to correspond to tool functions, such as scoring or cutting. Positioning portion 75 further includes alignment and support wall 88 and spaced blade receiving wall 89 (see FIGS. 4 through 9). As shown in FIG. 6, cutting blade 43 is received and held between walls 88 and 89 thus limiting blade rattle, the walls supporting pin 87 at both sides thereby preventing pin deflection under load. These components of blade positioning portion 75 are cooperative with blade positioning features 41 of housing 23 to maintain a selected cutting blade 43 location at housing 23 once installed with securement 25 returned to the operative, position in housing 23.

Referring to FIGS. 6 through 9, latching structure 79 is releasably engageable with catch 55 of housing 23 when securement 25 is pivoted to the operative position (ready for use in cutting material). Structure 79 includes yieldable latch 91, a resilient arm (a living hinge, for example) located at the end of securement 25 and having portion 93 at the end thereof configured to releasably engage catch 55. Preferably, portion 93 is a detent configured to capture catch 55, though different structures (reversing the structures, for example) could be conceived. Latch 91 includes projection 95 adjacent to portion 93 which is positioned and configured for manual access. When a user presses on projection 95, latch 91 is depressed thereby releasing portion 93 from catch 55 and allowing a user to manipulate securement 25.

While preferably located at securement 25, tape measure blade receiving slot structure 77 may be defined by either or both housing 23 and/or securement 25. Again referring to FIGS. 6 through 9, slot structure 77 defines tape measure blade receiving slot 99 (FIGS. 1 and 3) adjacent to said cutting blade positioning portion 75 at nose portion 71 of securement 25. Slot structure 77 includes engagement 101 releasably engagable at blade anchoring gap feature 21 of tape measure blade 19 when the tape measure blade is inserted into receiving slot 99. Engagement 101 is preferably a protruding lip located at wall 102 of blade engaging clip 103, a yieldable yet resilient tongue anchored to the remaining structure of securement 25 only along the bottom edge. Blade anchoring gap engaging lip 101 is located at the distal end thereof (spaced from the bottom edge) which yields to insertion or withdrawal of blade 19 of tape measure 17, thus allowing releasable engagement of gap 21 by lip 101 thereby securing blade 19 in slot 99 during measuring.

As may be appreciated from the foregoing, an improved tool is disclosed for measuring and cutting construction materials (such as drywall or the like). The tool is convenient to use and store, its compact configuration lending itself to most applications. Cutting (and scoring) blades are easy to access and reposition, such operations accomplished with a minimum of complexity or risk of lost parts. The tool has few parts and is thus inexpensive to manufacture, and is safe and durable. Securement 25 is preferably made of molded plastic material, and housing 23 is preferably formed from metal.

What is claimed is:

1. A measuring and cutting tool comprising:
a housing including first and second opposed walls and a cutting blade opening; and
a securement held at said housing between said first and second opposed walls and deployable therefrom, said securement including a cutting blade positioning portion at one end thereof and a tape measure blade receiving slot at said one end adjacent to said cutting blade positioning portion.

2. The tool of claim 1 wherein said housing includes first and second housing portions each having one of said first and second opposed walls thereat, at least one of said housing portions including locating structure at said one of first and second opposed walls thereat for limiting movement of said securement when held at said housing and for releasably retaining said securement at said housing.

3. The tool of claim 2 wherein said locating structure includes a catch and wherein said securement includes a yieldable latch releasably engageable by said catch.

4. The tool of claim 1 wherein said securement includes a second end spaced from said one end and a spare blade retainer located between said cutting blade positioning portion and said second end.

5. The tool of claim 1 wherein said cutting blade positioning portion of said securement is cooperative with blade positioning features defined at least at one of said first and second opposed walls of said housing to maintain a selected cutting blade position when installed.

6. The tool of claim 1 wherein said tape measure blade receiving slot at said one end of said securement includes a slot wall having a lip defined thereat and positioned and configured to engage with a tape measure blade feature.

7. A hand tool for measuring and cutting comprising:
a housing including first and second opposed walls and a cutting blade opening at one end of said housing and defined between said opposed walls, said housing having a catch located at said one end and a pivot located at said first opposed wall adjacent to a second end of said housing opposite said one end; and
a securement having a nose and a tail, said tail connected at said pivot of said housing for pivotable deployment of said securement from said housing, said nose of said securement including a cutting blade positioning portion, a tape measure blade receiving slot and a latching structure, said latching structure releasably engageable with said catch of said housing when said securement is pivoted to an operative position.

8. The hand tool of claim 7 wherein said latching structure of said nose of said securement includes a resilient arm having a detent thereat for capture of said catch of said housing.

9. The hand tool of claim 8 wherein said resilient arm of said latching structure includes a projection adjacent to said detent positioned and configured for manual access to depress said arm thereby to release and pivot said securement.

10. The hand tool of claim 7 wherein said cutting blade positioning portion of said nose of said securement includes at least one blade locating node for user selection of different blade installation locations relative to said cutting blade opening at said housing.

11. The hand tool of claim 7 wherein said securement includes a spare blade retainer defined thereat.

12. The hand tool of claim 7 wherein said tape measure blade receiving slot at said nose of said securement includes a tape measure blade engaging clip adjacent thereto.

13. The hand tool of claim 7 wherein said housing includes a widened arcuate surface at said one end opposite said cutting blade opening.

14. A tool for measuring, scoring and cutting and configured for use with a tape measure having a tape measure blade at one end, the tape measure blade having a blade anchoring gap therethrough, said tool comprising:
a housing having a cutting blade opening at one end;
a releasable securement locatable in said housing for positioning a cutting blade in said housing; and
a tape measure blade receiving slot structure defined at least at one of said housing and said securement, said slot structure including an engagement releasably engagable at the blade anchoring gap of the tape measure blade when the tape measure blade is inserted into said receiving slot structure.

15. The tool of claim 14 wherein said housing includes a catch at said one end and wherein said securement includes a mount pivotably held at a second end of said housing spaced from said one end, a resilient arm located at said securement and having a portion releasably engageable at said catch of said housing.

16. The tool of claim 15 wherein said housing includes first and second housing portions each having an inner wall, at least one of said housing portions including locating structure at said inner wall thereof for limiting pivoting movement of said securement in one direction.

17. The tool of claim 14 wherein said engagement of said slot structure includes a yieldable resilient tongue having a blade anchoring gap engaging lip located thereat.

18. The tool of claim 14 wherein said securement includes at least a first cutting blade locating node defining first and second available blade positions relative to said cutting blade opening of said housing.

19. The tool of claim 14 wherein said housing includes a widened arcuate surface at said one end opposite said cutting blade opening, said surface including gripping striations thereat.

20. The tool of claim 14 wherein said securement includes a spare blade retainer.
